(19) United States
(12) Patent Application Publication
(10) Pub. No.: US 2026/0148466 A1
(43) Pub. Date: May 28, 2026

(54) METHODS AND SYSTEMS FOR NON-LINEAR INTERPOLATION OF CURVE NETWORKS FOR KEYFRAME DEFORMATIONS

(71) Applicant: Adobe Inc., San Jose, CA (US)

(72) Inventors: Jean-Marc Thiery, Paris (FR); Tamy Boubekeur, Paris (FR); Stephanie Wang, San Jose, CA (US); Qingnan Zhou, New York, NY (US); Jeremie Dumas, Seattle, WA (US); Giorgio Gori, San Jose, CA (US); Patrick Schmidt, Aachen (DE)

(21) Appl. No.: 18/959,053

(22) Filed: Nov. 25, 2024

(51) Int. Cl. G06T 13/80

(52) U.S. Cl. CPC G06T 13/80

(57) ABSTRACT

An animation system receives a curve network is bound to a rest pose of an animated object. The animation system receives an initial keyframe and a destination keyframe of the curve network. The initial keyframe represents a corresponding starting pose of the animated object and the destination keyframe represents a corresponding destination pose of the animated object. The animation system generates a sequence of intermediate curve networks representing poses of the object between the initial keyframe and the destination keyframe. The animation system generates the sequence of intermediate curve networks by interpolating from the initial keyframe to the destination keyframe using the curve network. The animation system then renders the initial keyframe, the sequence of intermediate curve networks, and the destination keyframe to generate an animation of the object from the initial keyframe to the destination keyframe.

### TECHNICAL FIELD

This disclosure relates generally to object animation, and more particularly to non-linear interpolation techniques for generating intermediate deformation curve networks between an initial keyframe and a destination keyframe.

### BACKGROUND

Computer-aided animators use various shape deformers for animating objects. The shape deformers may include skeleton representations of the object, cages, blend shapes, etc. The shape deformers define a structure of the object and connects surface features of the object to the structure. The shape deformers allow for approximating physical relationships between parts of the object to enable realistic animations of the object. Shape deformers can be used alone, in parallel, or in sequences (e.g., referred to a deformer stack). While shape deformers may be useful for global control of particular object shapes (e.g., such a skeleton deformer for humanoid characters, etc.), shape deformers are not appropriate for precise detailed surface deformations or for modeling sharp discontinuities (e.g., creases in subdivision surfaces, etc.) because the control structure of the deformer is not tied to the deformed surface at the vertex level.

### SUMMARY

Methods and systems are described herein for improved interpolation of keyframes for computer-aided animation. A computing system provides for the animation of characters and objects. In some examples, the computing system automates aspects of the animation process by generating frames between a first pose of a character and/or object and a second pose of the character and/or object. The computing system receives a curve network representing a control structure bound to the rest pose of a character or object. The curve network includes nodes connected by edges whose geometry is located on (or near) a surface of the object to deform. The computing device includes a rendering pipeline that translates deformations in a curve network to corresponding deformations to the surface of the character or object. The computing device also receives an initial keyframe representing an initial pose of the character or object that will be rendered and a destination keyframe representing a destination pose of the character or object.

The computing device executes a non-linear interpolation technique to generate intermediate curve networks that correspond to poses of the character or object from the initial keyframe to the destination keyframe. The computing device modifies the intermediate curve networks by minimizing the thin-shell energy of shapes controlled by the curve network. The computing device then renders the initial keyframe, modified intermediate curve networks, and destination keyframes to create an animated representation of the character or object that smoothly moves from the initial pose to the destination pose.

The methods, systems, and non-transitory computer-readable media and systems described herein include various media editing systems and operations as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example operation of an interpolation of keyframes for computer-aided animation according to aspects of the present disclosure.

FIG. 2 illustrates an example of a curve network to surface deformation pipeline according to aspects of the present disclosure.

FIG. 3 illustrates an example application of curve network deformations according to aspects of the present disclosure.

FIG. 4 illustrates an example a framed Bezier curve in three dimensions according to aspects of the present disclosure.

FIG. 5 illustrates an example of transformed half-edge geometry seen through non-integrable per-triangle Jacobians according to aspects of the present disclosure.

FIG. 6 illustrates an example backward pass computation of the Jacobian matrix of the shell-energy residuals with respect to curve network parameters according to aspects of the present disclosure.

FIG. 7 illustrates a flowchart of an example process for interpolating keyframes to generate interpolated animation frames according to aspects of the present disclosure.

FIG. 8 illustrates an example computing device architecture of an example computing device that can implement the various techniques described herein according to aspects of the present disclosure.

### DETAILED DESCRIPTION

Methods and systems are described herein for improved interpolation of keyframes for computer-aided animation. While there are conventional techniques for keyframe interpolation, such conventional techniques are designed to interpolate shapes directly, and not control structures such as deformation curve network. Conventional techniques interpolate surface geometry of an object to generate an interpolated representation of the object between an initial representation of the object and destination representation of the object. Since surface interpolation ignores the underlying shape deformer, the shape deformer does not fit to the interpolated surface of the interpolated representation of the object. As a result, the interpolated representation of the object cannot be edited once generated as any edits to the interpolated representation will create unpredictable visual incongruities. Thus, surface-based interpolation techniques provide less control of over animation process and often require more frequent interpolations (e.g., such as editing interpolated representations, etc.) causing significant processing overhead and time.

The methods and systems described herein include an improved interpolation of keyframes for computer-aided animation that operates on curve networks to generate interpolated keyframes that maintain editability through interpolated curve networks. By interpolating curve networks as a shape deformer of the objects of a keyframe, the interpolated keyframe maintains a connection between the interpolated curve network and the surface geometry. The interpolated keyframe can be edited or interpolated to generate additional interpolated keyframes. The improved interpolation techniques described herein enable adding new fine-details and control of curves to the existing animation in an iterative process, allowing for coarse-to-fine surface animation.

An animation system executes operations to process animated objects, keyframes, curve networks, generate additional frames via interpolation, and/or the like. In some instances, the animation system operates as software executing on a computing device or server. In other implementations, the animation system operates as a hardware platform (e.g., such as an application specific integrated circuit (ASIC), field-programmable gate array (FPGA), special-purpose computer, and/or the like). In still yet other implementations, the animation system operates as combination of software and hardware. In some examples, the animation system operates within a distributed environment via one or more computing devices, databases, servers, etc. A user operates the animation system directly (e.g., via an input interface of the animation system or via a computing device executing the animation system, etc.). Alternatively, or additionally, the user accesses the animation system remotely via a computing device through interfaces exposed by animation system enabling a user to operate the animation system.

A curve network is a three-dimensional (3D) shape deformation tool. The curve network models the deformation field of an object through editing of the curve network's rest pose configuration (e.g., similar to a skeleton shape deformer or a cage deformer, etc.) and is tied to the surface geometry of the animated object. Curve networks provide precise control of intended crease discontinuities of the animated object, exact vertex position control along profile curves, anisotropic stretch, etc. The animation system generates a curve network during generation of the animated object. In some examples, the animation system generates the curve network automatically (e.g., using image processing techniques, machine-learning techniques, and/or the like). In other examples, an animator generates the curve network before, during, or after generating the animated object. The curve network includes nodes connected by edges. During animation of frames, the animation system uses the nodes and edges to model the propagation of changes when a node or edge is moved, etc.

The animation system uses linear and/or non-linear interpolation to generate frames between two keyframes. In some examples, the animation system receives curve network of a rest pose of an animated object, an initial keyframe including an initial pose of the animated object, and a destination keyframe including a destination pose of the animated object. In some instance, the animation system also receives a rest-pose mesh (e.g., a three-dimensional model of the animated object). The animation system uses non-linear interpolation to generate a sequence of intermediate curve networks representing poses of the object from the initial keyframe to the destination keyframe. When rendered by the animation system, the sequence of intermediate curve networks, provide an appearance of fluid motion of the animated object moving from the initial to the destination pose. In some examples, the animation system modifies the sequence of intermediate curve networks by minimizing a thin-shell energy. The thin-shell energy compares dihedral angles and edge lengths of deformed surface geometries to target quantities defined by linear interpolation between the initial pose and the destination pose. The animation system evaluates the dihedral angles and edge lengths based on the smoothly interpolated deformation fields. The animation system then renders the modified sequence of intermediate curve networks using a rendering pipeline that maps the modified curve networks to surface geometries of the animated object.

For example, the animation system receives a triangle mesh input M=(V, F) with three-dimension (3D) rest-pose vertex positions Vᵣₑₛₜ∈| [symbol] ^{|V|×3}, as well as a compatible pair of curve networks Cᵣₑₛₜ and C_{curr} (defined below) in rest and current deformed pose, respectively. The output is a matrix of deformed vertex positions V_{curr}∈ [symbol] ^{|V|×3}.

A curve network is a tuple, C=(P, N, T, Γ). The animation system describes the geometry of the curve network as a set of node positions P={Pᵢ∈ [symbol] ^{e}} with associated normal vectors N={nᵢ∈ [symbol] ∥nᵢ∥=1} and a set of tangent control points, organized in pairs, T={t₂ⱼ, t₂ⱼ₊₁∈ [symbol] ³}.

The animation system defines a connectivity of [symbol] by a set of cubic Bézier curves Γ={γⱼ: [symbol] → [symbol] ³}, each connecting two nodes of the curve network. That is, a curve γⱼ relies on four control points (P₀, t₁, t₂, P₃), where P₀, P₃∈P and t₁, t₂∈T. A node Pᵢ can be incident to one or multiple curves, but each pair of tangent points is assigned to a single curve.

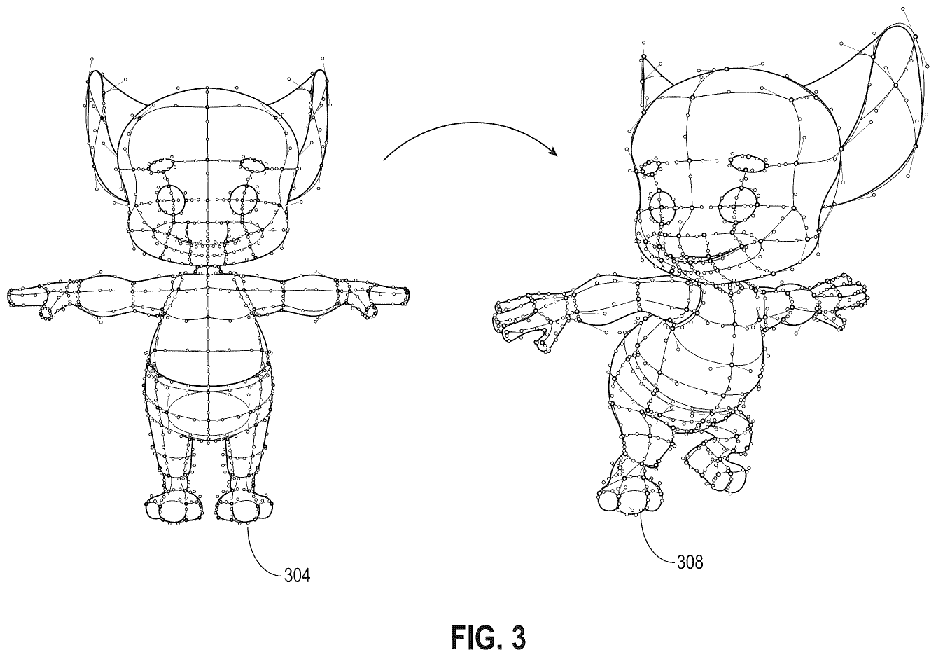

The animation system parameterizes the geometry of a curve network by combining the continuous quantities [symbol] and [symbol] in a variable vector x∈ [symbol] ⁿ, with n=3|P|+3|N|+3|T|. Each curve γⱼ(u) includes an orthogonal frame [n̅(u), t̅(u), b̅(u)]∈ [symbol] ^{3×3}, that smoothly interpolates the node normals and tangents at the endpoints, see FIG. 3. The animation system evaluates the frames by executing the following steps:
1) Discretize each curve γ(u) as a piecewise linear polyline by sampling the curve at a fixed sequence of parametric locations u₀, . . . , uₖ.
2) For each of segment k, choose as frame tangent the vector connecting its two sample points: t̅ᵢ γ(u)−γ(uᵢ₋₁).
3) Starting at one endpoint of the curve, compute a sequence of candidate normals n̅ᵢ (disregarding torsion in this first pass):
   a) Choose n̅₁ by orthogonalizing it with the curve tangent vector.
   b) Sequentially compute n̅ᵢ₋₁ as Rᵢ\hat{n}ᵢ by finding the minimum rotation matrix Rᵢ aligning the tangent vector t̅ᵢ to t̅ᵢ₊₁.
4) At the endpoint, compute the torsion integrated along the curve θ by comparing the propagated normal \hat{n}ₖ to the node normal orthogononalized to the end tangent.
5) In a second sweep along the polyline, distribute the total torsion θ linearly with respect to curvilinear abscissa.

At each segment, the animation system derives a bi-normal b̅ᵢ as b̅ᵢ=n̅ᵢ×t̅ᵢ. For isotropic frames, the animation system scales each b̅ᵢ and n̅ᵢ to a same length as tᵢ.

Two geometric instances of a curve network Cᵣₑₛₜ (e.g., a curve network of a rest pose, etc.) and C_{curr}(e.g., a curve network of a current pose, etc.) define a linear deformation Fᵢ∈ [symbol] ^{3×3} per segment:

$${F}_{i} = {[ {\overline{n}}_{i} , {\overline{t}}_{i} , {\overline{b}}_{i} ]}_{c u r r} \cdot {[ {\overline{n}}_{i} , {\overline{t}}_{i} , {\overline{b}}_{i} ]}_{rest}^{- 1} .$$

The animation system reshapes the set of per-segment deformations Fᵢ∈ [symbol] ^{3×3} into a matrix F^{c}∈ [symbol] ^{|seg|×9}. In some instances, the animation system represents the matrix as F^{c}(x) (e.g., treating the instance Cᵣₑₛₜ as constant and C_{curr} as parametrized by x∈ [symbol] ⁿ).

In some examples, the animation system defines the faces of [symbol] to be triangular. In other instances, the faces of [symbol] may be polygonal. The animation system projects deformation gradients from discrete curve segments to vertices of the mesh via closed point projection from segment midpoints to barycentric locations on triangles. In some implementations, the animation system inserts the barycentric footpoints as new vertices into the mesh in a preprocess. The animation system, based on the projection partitions the vertices V into sets of constrained vertices V_{c} and free vertices V_{f}. The animation system assembles the linear operator B_{c}∈ [symbol] ^{|V}^{_{|x|seg|}}, in which each row i sums to 1 and marks the vertices of V_{c} that receive the deformation associated with segment i. In some instances, the linear operator is fixed. The animation system uses the linear operator at deformation time to obtain deformation gradients at all constrained vertices:

$${F}_{c}^{V} ( x ) = {B}_{c} \cdot {F}^{C} ( x ) ∈ {ℝ}^{\vert {V}_{c} \vert \times 9} .$$

The animation system propagates the deformation gradients

$${F}_{c}^{V} ∈ {ℝ}^{\vert {V}_{c} \vert \times 9}$$

at the subset of constrained vertices to the set of free vertices V_{f} via harmonic interpolation. The animation system propagates the deformation gradients over a surface by solving the sparse linear system

$${L}_{f f} \cdot {F}_{f}^{V} = - {L}_{f c} \cdot {F}_{c}^{V} ( x ) ,$$

where L∈ [symbol] ^{|V|×|V|} is a positive-definite discrete Laplace-Beltrami operator, with L_{ff} the square block corresponding to free vertices and L_{fc} the rectangular block referring to free rows and constrained columns.

The animation system averages the non-integrable, field of deformation gradients from vertices to their incident faces, before fitting new vertex positions V_{curr}∈ [symbol] ^{|V|×3} that match these per-triangle deformation gradients Fₜ∈ [symbol] ^{3×3}.

The animation system optimizes vertex positions that minimize

$${ε}^{P} ( V ) := {\sum }_{t ϵ F} {\sum }_{e ∈ t} {a}_{e}^{t} {‖ e - {F}_{t} {e}_{rest} ‖}^{2} \text{=:} {‖ \sqrt{{A}_{E}} ( {\partial }_{1} V - \overline{E} ) ‖}^{2}$$

$$s . t . {S}_{c}^{T} V = {V}_{c}$$

Where ∂₁ and Ē denote the half-edge discrete one-form matrix of size 3|F|×|V| (with two single +1 and −1 entries at the columns corresponding to the halfedge vertices) and the constrained halfedges respectively,

$${a}_{e}^{t}$$

denoting the e's Voronoi surface inside t and A_{E} its corresponding matrix. The animation system decomposes the vertices into free and constrained positions: V=S_{f}V_{f}+S_{c}V_{c} for the harmonic diffusion step (using the same, similar, or different constraint sets), and optimizing for the free vertices V_{f}, which can be expressed as:

$$V = {S}_{f} {V}_{f} = {S}_{c} {V}_{c} , with$$

$${V}_{f} = {( {( {\partial }_{1} {S}_{f} )}^{T} {A}_{E} {\partial }_{1} {S}_{f} )}^{- 1} {( {\partial }_{1} {S}_{f} )}^{T} {A}_{E} ( \overline{E} - {\partial }_{1} {S}_{c} {V}_{c} ) = {( {\partial }_{1}^{T} {A}_{E} {\partial }_{1} )}_{ff}^{- 1} {( {\partial }_{1}^{T} {A}_{E} \overline{E} )}_{f .} - {( {\partial }_{1}^{T} {A}_{E} {\partial }_{1} )}_{ff}^{- 1} {( {\partial }_{1}^{T} {A}_{E} {\partial }_{1} )}_{fc} {V}_{c} = {{L}_{ff}^{- 1} ( {\partial }_{1}^{T} {A}_{E} \overline{E} )}_{f .} - {L}_{ff}^{- 1} {L}_{fc} {V}_{c}$$

which minimizes ∥\sqrt{A_{E}}(∂₁S_{f}V_{f}−(Ē−∂₁S_{c}V_{c})∥². Note that,

$$L = {\partial }_{1}^{T} {A}_{E} {\partial }_{1}$$

is equivalent to the common construction of the Laplacian operator L using Discrete Exterior Calculus for the appropriate choice of halfedge area matrix A_{E}.

The animation system receives, as input, a rest-pose mesh with vertex positions Vᵣₑₛₜ∈ [symbol] ^{|V|×3}, a rest-pose curve network Cᵣₑₛₜ, as well as two deformed keyframe poses of the rest-pose curve network Cₖ₌₀ and C_{k=K}. The animation then outputs a sequence of deformed intermediate poses Cₖ₌₁, . . . C_{k=K-1}. The animation system optimizes one or more frame with respect to a discrete-shell energy. The discrete-shell energy compares current dihedral angles and edge lengths of a deformed surface to target quantities obtained from linear interpolation between the keyframe poses. The animation system evaluates dihedral angles and edge lengths based on the smoothly interpolated deformation fields. As a result, the animation system can ignore the subsequent Poisson interpolation step during optimization, enabling simplified and more efficient optimization.

The animation system modifies a common mesh-based thin-shell energy to express the mesh-based thin-shell energy with respect to diffused Jacobians {F^{v}}:

$${ε}_{shell} ( {F}^{V} ) := {\sum }_{t} {\sum }_{e ∈ t} \frac{1}{{L}_{e}^{2}} {( {L}_{e} ( {F}_{t} ) - {\overline{l}}_{e} ( w ) )}^{2} + γ {\sum }_{e = {t}_{1} ⋂ {t}_{2}} \frac{{L}_{e}^{2}}{{A}_{e}^{2}} ( {θ}_{e} ( {F}_{{t}_{1}} , {F}_{{t}_{2}} ) - {\overline{θ}}_{e} ( w ) )$$

### With:

$${F}_{t} := \frac{{F}_{{t}^{0}}^{V} + {F}_{{t}^{1}}^{V} + {F}_{{t}^{2}}^{V}}{3} {∀}_{t}$$

$${l}_{e} ( F ) := ‖ Fe ‖$$

$${\overline{l}}_{e} ( w ) = {\sum }_{k} {w}_{k} {l}_{e} ( {F}_{t}^{( k )} ) , for t ∋ e$$

$${θ}_{e} ( {F}_{1} , {F}_{2} ) := {atan}_{2} ( \frac{\vert {F}_{1} , {n}_{{t}_{1}} ; {F}_{2} , {n}_{{t}_{2}} ; {F}_{1} e \vert}{‖ {F}_{1} e ‖} ; ( {F}_{1} , {n}_{{t}_{1}} ) \cdot ( {F}_{2} , {n}_{{t}_{2}} ) )$$

$$for e ∈ {t}_{1} , opp ( e ) ∈ {t}_{2}$$

$${\overline{θ}}_{e} ( w ) = {\sum }_{k} {w}_{k} {θ}_{e} ( {F}_{{t}_{1}}^{( k )} , {F}_{{t}_{2}}^{( k )} )$$

The animation system uses the modified edge lengths and dihedral angles as geometric descriptors to be interpolated at keyframes. The animation system measures the quantities of the edge lengths and dihedral angles through the diffused deformation Jacobians

$$\{ {F}_{v}^{V ( k )} \}$$

at keyframe k, corresponding to the keyframed curvenet. Since, in the general case,

$$\{ {F}_{v}^{V ( k )} \}$$

are not integrable, opposite half-edges have different geometric descriptors:

$${l}_{e} ( {F}_{{t}_{1}}^{( k )} ) \neq {l}_{opp ( e )} ( {F}_{{t}_{2}}^{( k )} ) , for e ∈ {t}_{1} , opp ( e ) ∈ {t}_{2}$$

$${θ}_{e} ( {F}_{{t}_{1}}^{( k )} , {F}_{{t}_{2}}^{( k )} ) \neq {θ}_{opp ( e )} ( {F}_{{t}_{2}}^{( k )} , {F}_{{t}_{1}}^{( k )} ) ,$$

as the (non-integrable) deformation Jacobians of neighboring triangles do not transform their common edge similarly in general.

This representation ensures keyframe interpolation, as εₛₕₑₗₗ is null at keyframe k for the keyframe's corresponding deformation Jacobians. Minimizing εₛₕₑₗₗ for trivial weights w=(0, . . . , 0, 1, 0, . . . ,0) results in the keyframes diffused Jacobians (and associated keyframed curvenet). In some examples, the animation system predefines a constant value for γ such as γ=0.01. In other examples, γ has a different predefined value or a variable value.

The animation system optimizes the sequence of deformed intermediate poses (i.e., the interpolated poses, etc.) by minimizing a thin-shell energy of each intermediate pose. For example, per intermediate frame k, the animation system minimizes a discrete-shell energy

$${ε}_{shell}^{k}$$

with respect to the vector of curve network parameters x∈ [symbol] ⁿ:

$$\begin{matrix}min \\ x ∈ {ℝ}^{n}\end{matrix} {ε}_{s h e l l}^{k} ( {F}^{V} ( {F}^{C} ( x ) ) ) .$$

The discrete-shell energy (e.g., εₛₕₑₗₗ(F^{v}) as previously described) is a sum of squared residuals r∈ [symbol] ^{m} expressed as:

$${ε}_{shell}^{k} = {‖ r ( {F}^{V} ( {F}^{C} ( x ) ) ) ‖}^{2}$$

The animation system begins at keyframe k=0 using the associated curve network parameters x⁰ of keyframe k=0. The shell energy

$${ε}_{shell}^{0} ( {x}^{0} )$$

evaluates to 0 here. Similarly, the shell energy of the destination keyframe

$$k = K {ε}_{shell}^{K} ( {x}^{K} )$$

also evaluates to 0. The animation system may operate on the frames sequentially (e.g., frame k to frame k+1) and initialize each x^{k+1} with the optimized result of frame k. Alternatively, or additionally, the animation system operates on the frames starting from keyframe k=K working backwards towards k=0, operate on the frames out of order (e.g., any arbitrary order, operate on frames in parallel, and/or the like.

For each frame k, the animation system linearizes the inner residual term r in εₛₕₑₗₗ at the current point x as: \hat{r}(x+d)=r(x)+J(x)·d, with direction d∈ [symbol] ⁿ and Jacobian matrix

$$J = \frac{\partial r}{\partial x} ∈ {ℝ}^{m \times n} .$$

Minimizing εₛₕₑₗₗ under this approximation amounts to a quadratic problem argmin_{de} [symbol] ∥r+Jd∥², which is solved by the linear system: 2J^{T}Jd=2J^{T}r, where −2J^{T}r is the gradient of εₛₕₑₗₗ and 2J^{T}Jd a positive semi-definite Hessian approximation. In each iteration (i.e., each intermediate pose), the animation system solves the system and updates x:=x+sd, with step size s∈ [symbol] , determined via backtracking line search.

The animation system then derives a Jacobian matrix J∈ [symbol] ^{m×n} per iteration as:

$$J = \frac{\partial r}{\partial {F}^{V}} \cdot \frac{\partial {F}^{V}}{\partial {F}^{C}} \cdot \frac{\partial {F}^{C}}{x} .$$

The first factor

$$\frac{\partial r}{\partial {F}^{V}} ∈ {ℝ}^{m \times \vert V \vert \times 9}$$

is a sparse tensor assembled via the gradient expressions of εₛₕₑₗₗ (F^{v}) as previously described. In some examples, the animation system derives the value using an automatic differentiation technique. In other instances, the animation systems derives the value using other techniques. The animation system derives the value of the third factor,

$$\frac{\partial {F}^{C}}{x} ∈ {ℝ}^{\vert seg \vert \times 9 \times n}$$

(which describes a change of deformation gradients at curve samples in terms of the network parameters) in the same way as the first factor. Alternatively, the animation system derives the value of the third factor using different techniques. The second factor,

$$\frac{\partial {F}^{V}}{\partial {F}^{C}} ,$$

reduces to a linear operator

$$Φ = \frac{\partial {F}^{V}}{\partial {F}^{C}} ∈ {ℝ}^{\vert V \vert \times \vert seg \vert}$$

and may remain constant. In some instances, the animation system derives the value of second factor in advance (e.g., such as when an initial keyframe is loaded, when the animation system executes, and/or the like).

The animation system performs the diffusion of a particular instance of deformation gradients at constrained vertices V_{c} over the entire mesh by deriving the linear system

$${L}_{ff} \cdot {F}_{f}^{V} = - {L}_{fc} \cdot {F}_{c}^{V} ( x )$$

in each forward pass through. In some instances, the animation system derives the linear operator that represents the harmonic diffusion in advance (e.g., such as when an initial keyframe is loaded, when the animation system executes, and/or the like). Alternatively, the animation system derives the linear operator at runtime (e.g., during interpolation, etc.).

The animation system derives the linear operator by harmonically diffusing a set of indicator functions (each marking a single curve segment) over the surface. The matrix B_{c}∈ [symbol] ^{|V}^{_{c}}^{|×|seg|}| maps from curve segments to constrained mesh vertices. The set of indicator functions mapped to the constrained mesh vertices is B_{c}·Id=B_{c}. The animation system defines the diffused indicator functions B_{f} at all other vertices using L_{ff}·B_{f}=−L_{fc}·B_{c}.

The animation system combines B_{c} and B_{f} into the matrix Φ via the respective selection matrices S_{c}∈{0,1}^{|V}^{_{c}}^{|×|V|} and

$${S}_{f} ∈ {\{ 0 , 1 \}}^{\vert {V}_{f} \vert \times \vert V \vert} \text{:} Φ = {S}_{f}^{T} {B}_{f} + {S}_{c}^{T} {B}_{c} ∈ {ℝ}^{\vert V \vert \times \vert seg \vert} \cdot T$$

Diffusing a particular instance F^{c} of deformation gradients at the curve segments to all mesh vertices corresponds to F^{v}=Φ·F^{c}.

In some examples, Φ initially is a dense matrix. In some instances, the influence of a curve segment over the mesh is often local, as multiple curves can mutually block their areas of influence. The animation system, in postprocessing, removes one or more entries under a certain threshold (e.g., such as, but not limited to 10⁻¹², etc.) to speed up the evaluation of derivatives as described above.

The animation system then renders the initial keyframe, the optimized sequence of intermediate poses (i.e., the interpolated frames optimized as described above), and the destination keyframe to generate a smooth animation of the mesh. In some examples, the animation system receives input selecting a particular intermediate pose of the sequence of intermediate poses. The input includes a modification to the intermediate pose (e.g., a modification to the surface deformation of the intermediate pose, the curve network of the intermediate pose, etc.). The animation system uses the curve network of the intermediate pose to implement the modification. Then, the animation system sets the particular intermediate pose as a new destination keyframe and generates intermediate poses between the initial keyframe and the new destination keyframe to implement the modification. Alternatively, or additionally, the animation system sets the particular intermediate pose as a new destination keyframe and generates intermediate poses between the new destination keyframe and the destination keyframe to implement the modification.

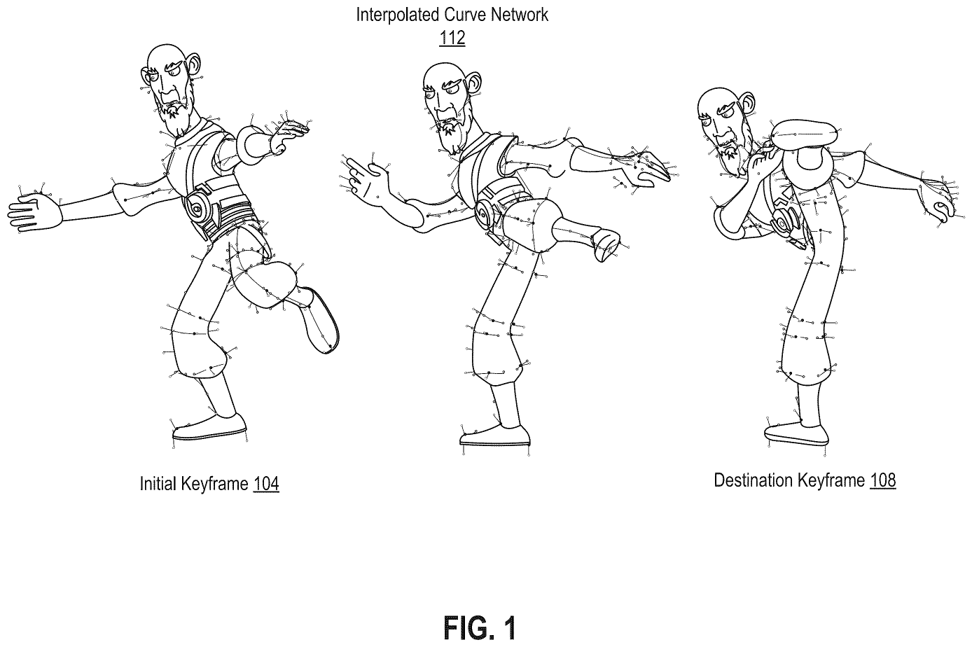

FIG. 1 illustrates an example operation of an interpolation of keyframes for computer-aided animation according to aspects of the present disclosure. An animation system receives initial keyframe 104 and destination keyframe 108. The animation system then generates a sequence of intermediate curve networks using interpolation. Interpolated curve network 112 is an example curve network generated by the animation system using initial keyframe 104 and destination keyframe 108. The animation system outputs the sequence of intermediate curve networks for further processing such as optimization and/or further editing (as previously described).

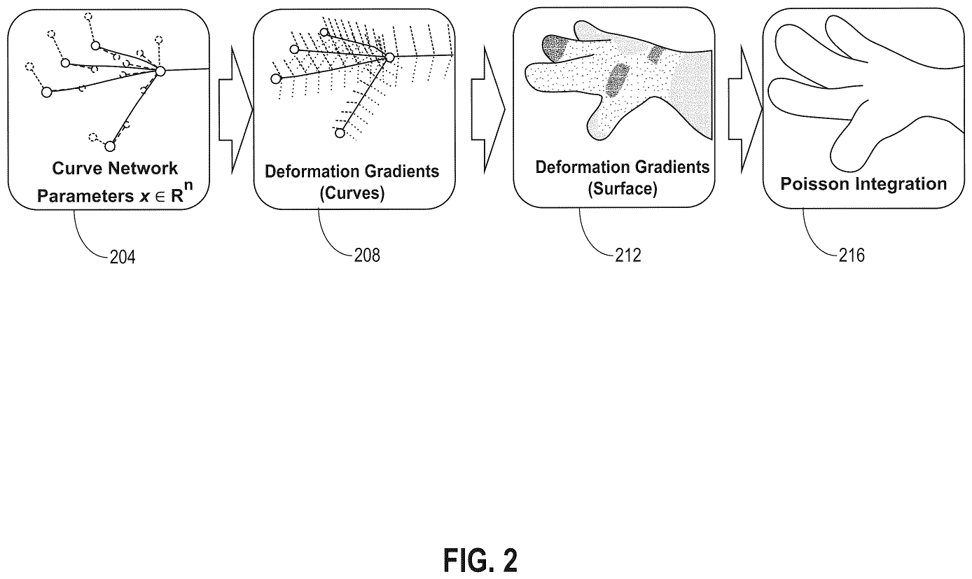

FIG. 2 illustrates an example of a curve network to surface deformation pipeline according to aspects of the present disclosure. A curve network to surface deformation pipeline maps a curve network representation of a three-dimensional mesh to a surface geometry of the three-dimensional mesh. The curve network to surface deformation pipeline includes one or more processing stages 204-216. In some examples, the one or more processing stages include stage 204 where the animation system receives an input curve network (or generated curve network), stage 208 where the animation system defines deformation gradients (curves), stage 212 where the animation system defines deformation gradients (surface), and stage 216 where the animation system performs Poisson integration to define the deformed surface geometry. The input curve network of stage 204 includes continuous description of curve network parameters, x∈ [symbol] ⁿ. At stage 208, the animation system defines deformation gradients from the curve network parameters. In some instances, the animation system defines 3×3 deformation gradients per discrete curve segment of the curve network as Fᵢ∈ [symbol] ^{3×3}. The animation system then flattens the deformation gradients into a matrix expressed as: F^{c}∈ [symbol] ^{|seg|×9}. At stage 212, the animation system defines diffused deformation gradients per mesh vertex F^{v}∈ [symbol] ^{|V|×9}. The animation system propagates the deformation gradients to the set of vertices V_{f} of the curve network via harmonic interpolation. At stage 216, animation system averages the deformation gradients from vertices to their incident faces, before fitting new vertex positions V_{curr}∈ [symbol] ^{|V|×3} that match these per-triangle deformation gradients Fₜ∈ [symbol] ^{3×3} The animation system inserts positional constraints (e.g., at vertices of the curve network, edges of the curve network, etc.), by selects positions that ε^{P}(V) as previously described. In some instances, the animation system uses use a polygonal implementation rather than triangular.

FIG. 3 illustrates an example application of curve network deformations according to aspects of the present disclosure. An animation system maps curve networks to surface geometries enabling a user to modify a curve network and generate a corresponding surface geometry that corresponds to the modified curve network. The curve network 304 and curve network 308 illustrate an application of the processing pipeline shown in FIG. 2 to define surface geometries from curve networks. For example, curve network 304 represents a rest pose mesh of an animated object and curve network 308 represents a deformed pose mesh of the animated object. The animation receives a triangle mesh M=(V, F) with 3D rest-pose vertex positions Vᵣₑₛₜ∈ [symbol] ^{|V|×3} as well as a compatible pair of curve networks Cᵣₑₛₜ (e.g., curve network 304) and C_{curr} (e.g., curve network 308) in rest and current deformed pose, respectively. The animation system outputs a matrix of deformed vertex positions V_{curr}∈ [symbol] ^{|V|×3} that map the deformed curve network to the surface geometries of the triangle mesh (as previously described).

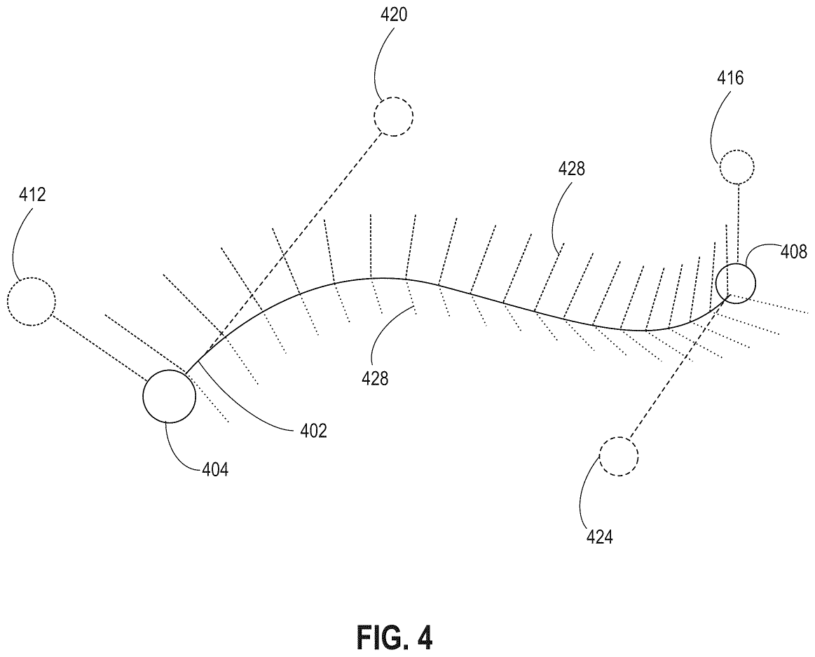

FIG. 4 illustrates an example a framed Bezier curve in three dimensions according to aspects of the present disclosure. Curve 202 corresponds to an edge of a curve network that spans node 404 and node 408. The animation system defines a frame for each curve γⱼ(u). The frame is an orthogonal frame represented by [n̅(u), t̅(u), b̅(u)]∈ [symbol] ^{3×3}. The frame is represented by lines 428 representing a three-dimensional geometry of the curve. The animation system defines normal 412 of node 404 and normal 416 of node 408. The animation system also defines node tangents such as tangent 420 at node 404 and tangent 424 at node 408. The animation system defines the normal and node tangents using interpolation. In some examples, the animation system receives input modifying a position of a node tangent and/or a normal. In response, the animation interpolates the changes to curve 402 and other normal and node tangents based on the modified position.

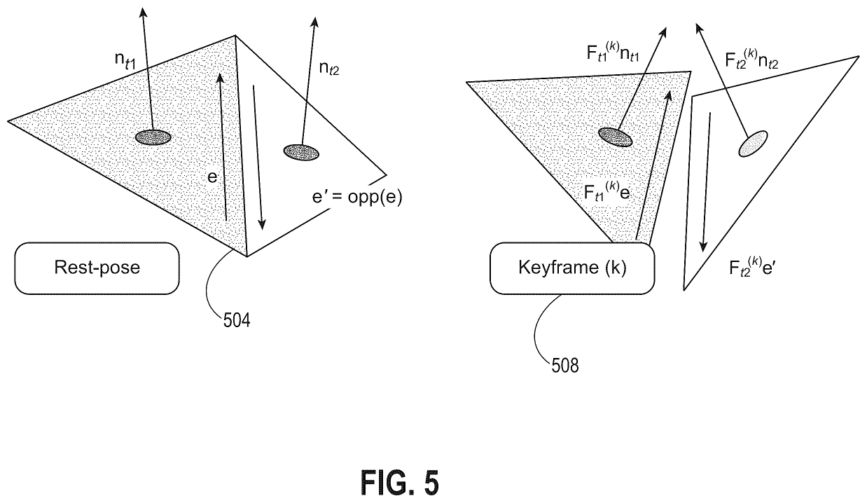

FIG. 5 illustrates an example of transformed half-edge geometry seen through non-integrable per-triangle Jacobians according to aspects of the present disclosure. The animation system expresses a mesh-based thin-shell energy with respect to diffused Jacobians (e.g., where each Jacobian is a matrix of first-order partial derivatives, etc.). The animation system uses curve networks to define thin-shell energies of meshes induced by the deformation of the curve networks. Thin-shell energies are useful for modeling elastic deformations of meshes. Triangles 504 represent input half-edge geometry of a rest pose and triangles 508 represented transformed half-edge geometry of a keyframe (e.g., keyframe (k)). Transformed half-edge geometry (e.g., represented by triangle 508) are represented through non-integrable per-triangle Jacobians. Opposite half-edge geometries cannot be stitched together in general as per-triangle Jacobians of adjacent triangles do not transform their shared edge similarly in the general case (such Jacobians are referred to as non-integrable).

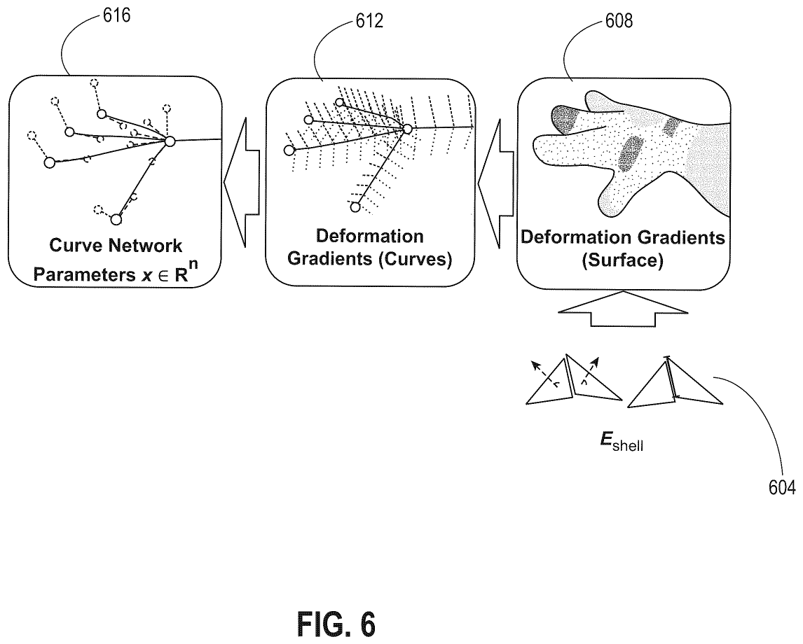

FIG. 6 illustrates an example backward pass computation of the Jacobian matrix of the shell-energy residuals with respect to curve network parameters according to aspects of the present disclosure. The animation system optimizes the sequence of deformed intermediate poses (i.e., the interpolated poses, etc.) by minimizing a thin-shell energy of each intermediate pose, which improves the propagation of deformations and corresponding appearance of the resulting mesh. Optimizing the sequence of intermediate poses improves the visual appearance of the intermediate poses by causing the deformations to appear more visually realistic (e.g., where surfaces stretch, contract, crease, etc.) based on movement of the mesh (determined based on the initial keyframe, the destination keyframe, or the sequence of intermediates poses, etc.), forces, and other portions of the mesh. The computing the optimization of the intermediate poses includes backwards pass computation of the Jacobian matrix of the shell-energy residuals with respect to curve network parameters.

The backward pass computation of the Jacobian matrix includes computing shell energies at 604, deformation gradients at surfaces at 608, deformation gradient at curves 612, and curve network parameters 616. The animation system computes the Jacobian matrix J∈ [symbol] ^{m×n} per iteration as:

$$J = \frac{\partial r}{\partial {F}^{V}} \cdot \frac{\partial {F}^{V}}{\partial {F}^{C}} \cdot \frac{\partial {F}^{C}}{x} .$$

The first factor

$$\frac{\partial r}{\partial {F}^{V}} ∈ {ℝ}^{m \times \vert V \vert \times 9}$$

is a sparse tensor assembled via the gradient expressions of εₛₕₑₗₗ(F^{v}) as previously described. In some examples, the animation system derives the value using an automatic differentiation technique. In other instances, the animation system derives the value using other techniques. The animation system derives the value of the third factor,

$$\frac{\partial {F}^{C}}{x} ∈ {ℝ}^{\vert seg \vert \times 9 \times n}$$

(which describes a change of deformation gradients at curve samples in terms of the network parameters) in the same way as the first factor. Alternatively, the animation system derives the value of the third factor using different techniques. The second factor,

$$\frac{\partial {F}^{V}}{\partial {F}^{C}} ,$$

reduces to a linear operator

$$Φ = \frac{\partial {F}^{V}}{\partial {F}^{C}} ∈ {ℝ}^{\vert V \vert \times \vert seg \vert}$$

and may remain constant. In some instances, the animation system derives the value of second factor in advance (e.g., such as when an initial keyframe is loaded, when the animation system executes, and/or the like).

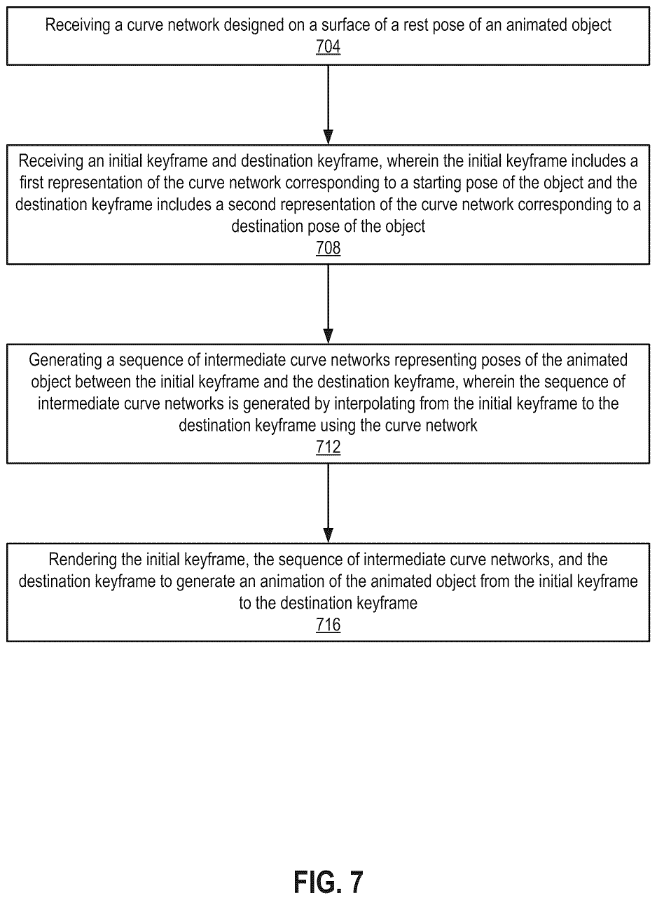

FIG. 7 illustrates a flowchart of an example process for interpolating keyframes to generate interpolated animation frames according to aspects of the present disclosure. In some implementations, an animation system operates as software operating on a computing device or server. In other implementations, the animation system operates as a hardware platform (e.g., such as an application specific integrated circuit (ASIC), field-programmable gate array (FPGA), special-purpose computer, and/or the like). In still yet other implementations, the animation system operates as a distributed environment via one or more computing devices, databases, servers, etc. In some instances, a user operates the animation system directly (e.g., via an input interface of the animation system or via a computing device executing the animation system, etc.). In other instances, a user may access the animation system via a computing device through interfaces exposed by animation system enabling a user to operate the animation system remotely.

At block 704, an animation system receives a curve network representing a control structure bound to the rest pose of an object (e.g., a mesh) to be animated. The curve network includes nodes connected by edges whose geometry is located on (or near) a surface of the object. The animation system receives the curve network from the user (e.g., as part of generating the animated object or animating the animated object) and/or from local or remote memory. In some instances, the animation system generates the curve network (e.g., from one or more animated objects, a description of the animated objects, and/or the like).

At block 708, the animation receives an initial keyframe and destination keyframe. The initial keyframe includes a first representation of the curve network corresponding to a starting pose of the object. The destination keyframe includes a second representation of the curve network corresponding to a destination pose of the object. A keyframe includes a representation of the curve network corresponding to a pose of the object. The animation system receives the initial keyframe and destination keyframe from the user (e.g., as part of generating the animated object or animating the animated object) and/or from local or remote memory. The animation system receives the initial keyframe and the destination keyframe at the same time as the curve network. Alternatively, the animation system receives the initial keyframe and the destination keyframe before or after receiving the curve network.

At block 712, the animation system generates a sequence of intermediate curve networks representing poses of the animated object between the initial keyframe and the destination keyframe. The animation system generates the sequence of intermediate curve networks by interpolating from the initial keyframe to the destination keyframe using the curve network (e.g., as previously described). In some examples, the animation system optimizes each intermediate curve network with respect to a discrete-shell energy of the intermediate curve network. For example, the animation system optimizes the sequence of intermediate curve networks by modifying the intermediate curve networks to minimize the discrete shell energy.

At block 716, the animation system renders the initial keyframe, the sequence of intermediate curve networks, and the destination keyframe to generate an animation of the animated object from the initial keyframe to the destination keyframe. Rendering the intermediate curve networks includes executing the rendering pipeline of FIG. 2 in which the animation system uses the intermediate curve network to define deformation gradients for curves of the intermediate curve network. The animation system averages the deformation gradients from vertices to their incident faces, before fitting new vertex positions V_{curr}∈ [symbol] ^{|V|×3} that match these per-triangle deformation gradients Fₜ∈ [symbol] ^{3×3}.

The animation system optimizes vertex positions that minimize

$${ε}^{P} ( V ) : = {\sum }_{t ∈ F} {\sum }_{e ∈ t} {a}_{e}^{t} {‖ e - {F}_{t} {e}_{rest} ‖}^{2} = : {‖ \sqrt{{A}_{E}} ( {\partial }_{1} V - \overline{E} ) ‖}^{2} s . t . {S}_{c}^{T} V = {V}_{c}$$

Where ∂₁ and Ē denote the half-edge discrete one-form matrix of size 3|F|×|V| (with two single +1 and −1 entries at the columns corresponding to the halfedge vertices) and the constrained halfedges respectively,

$${a}_{e}^{t}$$

denoting the e's Voronoi surface inside t and A_{E} its corresponding matrix. The animation system decomposes the vertices into free and constrained positions: V=S_{f}V_{f}+S_{c}V_{c} for the harmonic diffusion step (using the same, similar, or different constraint sets), and optimizing for the free vertices V_{f}, which can be expressed as:

$$V = {S}_{f} {V}_{f} = {S}_{c} {V}_{c} with {V}_{f} = {( {( {\partial }_{1} {S}_{f} )}^{T} {A}_{E} {\partial }_{1} {S}_{f} )}^{- 1} {( {\partial }_{1} {S}_{f} )}^{T} {A}_{E} ( \overline{E} - {\partial }_{1} {S}_{c} {V}_{c} ) = {( {\partial }_{1}^{T} {A}_{E} {\partial }_{1} )}_{ff}^{- 1} {( {\partial }_{1}^{T} {A}_{E} \overline{E} )}_{f .} - {( {\partial }_{1}^{T} {A}_{E} {\partial }_{1} )}_{ff}^{- 1} {( {\partial }_{1}^{T} {A}_{E} {\partial }_{1} )}_{fc} {V}_{c} = {{L}_{ff}^{- 1} ( {\partial }_{1}^{T} {A}_{E} \overline{E} )}_{f .} - {L}_{ff}^{- 1} {L}_{fc} {V}_{c}$$

which minimizes ∥\sqrt{A_{E}} (∂₁S_{f}V_{f}−(Ē−∂₁S_{c}V_{c})). Note that,

$$L = {\partial }_{1}^{T} {A}_{E} {\partial }_{1}$$

is equivalent to the common construction of the Laplacian operator L using Discrete Exterior Calculus for the appropriate choice of halfedge area matrix A_{E}.

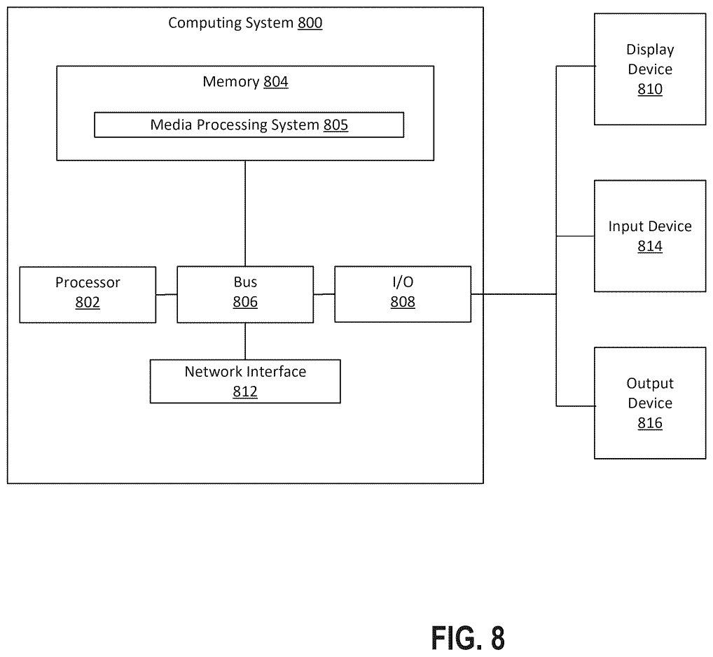

Any suitable computing system or group of computing systems can be used for performing the operations described herein. For example, FIG. 8 depicts a computing system 800 that can implement any of the computing systems or environments discussed above. In some embodiments, the computing system 800 includes a processing device 802 that executes the media processing system, a memory that stores various data computed or used by the media processing system, an input device 814 (e.g., a mouse, a stylus, a touchpad, a touch-screen, etc.), and an output device 816 that presents output to a user (e.g., a display device that displays graphical content generated by media processing system). For illustrative purposes, FIG. 8 depicts a single computing system on which the media processing system is executed, and the input device 814 and output device 816 are present. But these applications, datasets, and devices can be stored or included across different computing systems having devices similar to the devices depicted in FIG. 8.

The example of FIG. 8 includes a processing device 802 communicatively coupled to one or more memory devices 804. The processing device 802 executes computer-executable program code stored in a memory device 804, accesses information stored in the memory device 804, or both. Examples of the processing device 802 include a microprocessor, an application-specific integrated circuit (“ASIC”), a field-programmable gate array (“FPGA”), or any other suitable processing device. The processing device 802 can include any number of processing devices, including a single processing device.

The memory device 804 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C#, Visual Basic, Java, Python, Perl, JavaScript, and ActionScript.

The computing system 800 could also include a number of external or internal devices, such as a display device 810, or other input or output devices. For example, the computing system 800 is shown with one or more input/output (“I/O”) interfaces 808. An I/O interface 808 can receive input from input devices or provide output to output devices. One or more buses 806 are also included in the computing system 800. Each bus 806 communicatively couples one or more components of the computing system 800 to each other or to an external component.

The computing system 800 executes program code that configures the processing device 802 to perform one or more of the operations described herein. The program code includes, for example, code implementing the document-processing application 102 or other suitable applications that perform one or more operations described herein. The program code can be resident in the memory device 804 or any suitable computer-readable medium and can be executed by the processing device 802 or any other suitable processor. In some embodiments, all modules in the media processing system are stored in the memory device 804, as depicted in FIG. 8. In additional or alternative embodiments, one or more of these modules from the media processing system are stored in different memory devices of different computing systems.

In some embodiments, the computing system 800 also includes a network interface device 812. The network interface device 812 includes any device or group of devices suitable for establishing a wired or wireless data connection to one or more data networks. Non-limiting examples of the network interface device 812 include an Ethernet network adapter, a modem, and/or the like. The computing system 800 is able to communicate with one or more other computing devices (e.g., a computing device that receives inputs for document-processing application 102 or displays outputs of the document-processing application 102) via a data network using the network interface device 812.

An input device 814 can include any device or group of devices suitable for receiving visual, auditory, or other suitable input that controls or affects the operations of the processing device 802. Non-limiting examples of the input device 814 include a touchscreen, stylus, a mouse, a keyboard, a microphone, a separate mobile computing device, etc. An output device 816 can include any device or group of devices suitable for providing visual, auditory, or other suitable sensory output. Non-limiting examples of the output device 816 include a touchscreen, a monitor, a separate mobile computing device, etc.

Although FIG. 8 depicts the input device 814 and the output device 816 as being local to the computing device that executes the document-processing application 102, other implementations are possible. For instance, in some embodiments, one or more of the input devices 814 and the output device 816 include a remote client-computing device that communicates with the computing system 800 via the network interface device 812 using one or more data networks described herein.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving a curve network designed on a surface of a rest pose of an object; receiving an initial keyframe and destination keyframe, wherein the initial keyframe includes a first representation of the curve network corresponding to a starting pose of the object and the destination keyframe includes a second representation of the curve network corresponding to a destination pose of the object; generating a sequence of intermediate curve networks representing poses of the object between the initial keyframe and the destination keyframe, wherein the sequence of intermediate curve networks is generated by interpolating from the initial keyframe to the destination keyframe using the curve network; and rendering the initial keyframe, the sequence of intermediate curve networks, and the destination keyframe to generate an animation of the object from the initial keyframe to the destination keyframe.

Example 2 is the method of example(s) 1, further comprising: minimizing a thin-shell energy of at least one intermediate curve network of the sequence of intermediate curve networks, wherein the thin-shell energy is minimized with respect to a vector of curve network parameters of the at least one intermediate curve network.

Example 3 is the method of example(s) 1, further comprising: modifying a particular intermediate curve network of the sequence of intermediate curve networks; defining a new destination keyframe including a third representation of the curve network corresponding to the particular intermediate curve network; and generating a new sequence of intermediate curve networks representing poses of the animated object between the initial keyframe and the new destination keyframe.

Example 4 is the method of example(s) 1, wherein rendering the initial keyframe, the sequence of intermediate curve networks, and the destination keyframe includes: projecting one or more deformation gradients from discrete curve segments to vertices of the curve network.

Example 5 is the method of example(s) 1, further comprising: deriving a linear operator by harmonically diffusing a set of indicator functions marking curve segments of the curve network, wherein the linear operator is a matrix; reducing the linear operator by removing values that are less than a threshold value; and applying the linear operator to the sequence of intermediate curve networks during rendering.

Example 6 is the method of example(s) 1, wherein interpolating from the initial keyframe to the destination keyframe using the curve network includes: modifying edge lengths and dihedral angles of the initial keyframe to represent a common mesh-based thin-shell energy with respect to diffused Jacobians; and interpolating the edge lengths and the dihedral angles of the curve network of the initial keyframe.

Example 7 is the method of example(s) 1, wherein rendering the initial keyframe includes: defining surface deformation gradients using the initial keyframe representation of the curve network.

Example 8 is a system comprising: one or more processors; and a non-transitory computer-readable medium storing instructions that when executed by the one or more processors, cause the one or more processors to perform operations including: receiving a curve network designed on a surface of a rest pose of an animated object; receiving an initial keyframe and destination keyframe, wherein the initial keyframe includes a first representation of the curve network corresponding to a starting pose of the object and the destination keyframe includes a second representation of the curve network corresponding to a destination pose of the object; generating a sequence of intermediate curve networks representing poses of the animated object between the initial keyframe and the destination keyframe, wherein the sequence of intermediate curve networks is generated by interpolating from the initial keyframe to the destination keyframe using the curve network; defining a thin-shell energy of each intermediate curve network of the sequence of intermediate curve networks using a sum of squared residuals; modifying the sequence of intermediate curve networks based on the thin-shell energy; and rendering the initial keyframe, the sequence of intermediate curve networks, and the destination keyframe to generate an animation of the animated object from the initial keyframe to the destination keyframe.

Example 9 is the system of example(s) 8, wherein modifying the sequence of intermediate curve networks based on the thin-shell energy includes: minimizing the thin-shell energy of at least one intermediate curve network with respect to a vector of curve network parameters of the at least one intermediate curve network.

Example 10 is the system of example(s) 8, wherein the operations further include: modifying a particular intermediate curve network of the sequence of intermediate curve networks; defining a new destination keyframe including a third representation of the curve network corresponding to the particular intermediate curve network; and generating a new sequence of intermediate curve networks representing poses of the animated object between the initial keyframe and the new destination keyframe.

Example 11 is the system of example(s) 8, wherein rendering the initial keyframe, the sequence of intermediate curve networks, and the destination keyframe includes: projecting one or more deformation gradients from discrete curve segments to vertices of the curve network.

Example 12 is the system of example(s) 8, wherein the operations further include: deriving a linear operator by harmonically diffusing a set of indicator functions marking curve segments of the curve network; reducing the linear operator by removing values that are less than a threshold value; and applying the linear operator to the sequence of intermediate curve networks during rendering.

Example 13 is the system of example(s) 8, wherein interpolating from the initial keyframe to the destination keyframe using the curve network includes: modifying edge lengths and dihedral angles of a curve network of the initial keyframe to represent a common mesh-based thin-shell energy with respect to diffused Jacobians; and interpolating the edge lengths and the dihedral angles of the curve network of the initial keyframe.

Example 14 is the system of example(s) 8, wherein rendering the initial keyframe includes: defining surface deformation gradients using the initial keyframe representation of the curve network.

Example 15 is a non-transitory computer-readable medium storing instructions that when executed by one or more processors, cause the one or more processors to perform operations including: receiving a curve network designed on a surface of a rest pose of an animated object; receiving an initial keyframe and destination keyframe, wherein the initial keyframe includes a first representation of the curve network corresponding to a starting pose of the object and the destination keyframe includes a second representation of the curve network corresponding to a destination pose of the object; generating a sequence of intermediate curve networks representing poses of the animated object between the initial keyframe and the destination keyframe, wherein the sequence of intermediate curve networks is generated by interpolating from the initial keyframe to the destination keyframe using the curve network; deriving a linear operator by harmonically diffusing a set of indicator functions marking curve segments of the curve network; modifying the sequence of intermediate curve networks using the linear operator; and rendering the initial keyframe, the modified sequence of intermediate curve networks, and the destination keyframe to generate an animation of the animated object from the initial keyframe to the destination keyframe.

Example 16 is the non-transitory computer-readable medium of example(s) 15, wherein modifying the sequence of intermediate curve networks by minimizing a thin-shell energy of at least one intermediate curve network with respect to a vector of curve network parameters of the at least one intermediate curve network.

Example 17 is the non-transitory computer-readable medium of example(s) 15, wherein the operations further include: modifying a particular intermediate curve network of the sequence of intermediate curve networks; defining a new destination keyframe including a third representation of the curve network corresponding to the particular intermediate curve network; and generating a new sequence of intermediate curve networks representing poses of the animated object between the initial keyframe and the new destination keyframe.

Example 18 is the non-transitory computer-readable medium of example(s) 15, wherein rendering the initial keyframe includes: defining surface deformation gradients using the initial keyframe representation of the curve network.

Example 19 is the non-transitory computer-readable medium of example(s) 15, wherein the operations further include: reducing the linear operator by removing values that are less than a threshold value; and applying the linear operator to the sequence of intermediate curve networks during rendering.

Example 20 is the non-transitory computer-readable medium of example(s) 15, wherein interpolating from the initial keyframe to the destination keyframe using the curve network includes: modifying edge lengths and dihedral angles of a curve network of the initial keyframe to represent a common mesh-based thin-shell energy with respect to diffused Jacobians; and interpolating the edge lengths and the dihedral angles of the curve network of the initial keyframe.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving a curve network designed on a surface of a rest pose of an object;
receiving an initial keyframe and destination keyframe, wherein the initial keyframe includes a first representation of the curve network corresponding to a starting pose of the object and the destination keyframe includes a second representation of the curve network corresponding to a destination pose of the object;
generating a sequence of intermediate curve networks representing poses of the object between the initial keyframe and the destination keyframe, wherein the sequence of intermediate curve networks is generated by interpolating from the initial keyframe to the destination keyframe using the curve network; and
rendering the initial keyframe, the sequence of intermediate curve networks, and the destination keyframe to generate an animation of the object from the initial keyframe to the destination keyframe.

2. The method of claim 1, further comprising:
minimizing a thin-shell energy of at least one intermediate curve network of the sequence of intermediate curve networks, wherein the thin-shell energy is minimized with respect to a vector of curve network parameters of the at least one intermediate curve network.

3. The method of claim 1, further comprising:
modifying a particular intermediate curve network of the sequence of intermediate curve networks;
defining a new destination keyframe including a third representation of the curve network corresponding to the particular intermediate curve network; and
generating a new sequence of intermediate curve networks representing poses of the animated object between the initial keyframe and the new destination keyframe.

4. The method of claim 1, wherein rendering the initial keyframe, the sequence of intermediate curve networks, and the destination keyframe includes:
projecting one or more deformation gradients from discrete curve segments to vertices of the curve network.

5. The method of claim 1, further comprising:
deriving a linear operator by harmonically diffusing a set of indicator functions marking curve segments of the curve network, wherein the linear operator is a matrix;
reducing the linear operator by removing values that are less than a threshold value; and
applying the linear operator to the sequence of intermediate curve networks during rendering.

6. The method of claim 1, wherein interpolating from the initial keyframe to the destination keyframe using the curve network includes:
modifying edge lengths and dihedral angles of the initial keyframe to represent a common mesh-based thin-shell energy with respect to diffused Jacobians; and
interpolating the edge lengths and the dihedral angles of the curve network of the initial keyframe.

7. The method of claim 1, wherein rendering the initial keyframe includes:
defining surface deformation gradients using the initial keyframe representation of the curve network.

8. A system comprising:
one or more processors; and
a non-transitory computer-readable medium storing instructions that when executed by the one or more processors, cause the one or more processors to perform operations including:
receiving a curve network designed on a surface of a rest pose of an animated object
receiving an initial keyframe and destination keyframe, wherein the initial keyframe includes a first representation of the curve network corresponding to a starting pose of the object and the destination keyframe includes a second representation of the curve network corresponding to a destination pose of the object;
generating a sequence of intermediate curve networks representing poses of the animated object between the initial keyframe and the destination keyframe, wherein the sequence of intermediate curve networks is generated by interpolating from the initial keyframe to the destination keyframe using the curve network;
defining a thin-shell energy of each intermediate curve network of the sequence of intermediate curve networks using a sum of squared residuals;
modifying the sequence of intermediate curve networks based on the thin-shell energy; and
rendering the initial keyframe, the sequence of intermediate curve networks, and the destination keyframe to generate an animation of the animated object from the initial keyframe to the destination keyframe.

9. The system of claim 8, wherein modifying the sequence of intermediate curve networks based on the thin-shell energy includes:
minimizing the thin-shell energy of at least one intermediate curve network with respect to a vector of curve network parameters of the at least one intermediate curve network.

10. The system of claim 8, wherein the operations further include:
modifying a particular intermediate curve network of the sequence of intermediate curve networks;
defining a new destination keyframe including a third representation of the curve network corresponding to the particular intermediate curve network; and
generating a new sequence of intermediate curve networks representing poses of the animated object between the initial keyframe and the new destination keyframe.

11. The system of claim 8, wherein rendering the initial keyframe, the sequence of intermediate curve networks, and the destination keyframe includes:
projecting one or more deformation gradients from discrete curve segments to vertices of the curve network.

12. The system of claim 8, wherein the operations further include:
deriving a linear operator by harmonically diffusing a set of indicator functions marking curve segments of the curve network;
reducing the linear operator by removing values that are less than a threshold value; and
applying the linear operator to the sequence of intermediate curve networks during rendering.

13. The system of claim 8, wherein interpolating from the initial keyframe to the destination keyframe using the curve network includes:
modifying edge lengths and dihedral angles of a curve network of the initial keyframe to represent a common mesh-based thin-shell energy with respect to diffused Jacobians; and
interpolating the edge lengths and the dihedral angles of the curve network of the initial keyframe.

14. The system of claim 8, wherein rendering the initial keyframe includes:
defining surface deformation gradients using the initial keyframe representation of the curve network.

15. A non-transitory computer-readable medium storing instructions that when executed by one or more processors, cause the one or more processors to perform operations including:
receiving a curve network designed on a surface of a rest pose of an animated object;
receiving an initial keyframe and destination keyframe, wherein the initial keyframe includes a first representation of the curve network corresponding to a starting pose of the object and the destination keyframe includes a second representation of the curve network corresponding to a destination pose of the object;
generating a sequence of intermediate curve networks representing poses of the animated object between the initial keyframe and the destination keyframe, wherein the sequence of intermediate curve networks is generated by interpolating from the initial keyframe to the destination keyframe using the curve network;
deriving a linear operator by harmonically diffusing a set of indicator functions marking curve segments of the curve network;
modifying the sequence of intermediate curve networks using the linear operator; and
rendering the initial keyframe, the modified sequence of intermediate curve networks, and the destination keyframe to generate an animation of the animated object from the initial keyframe to the destination keyframe.

16. The non-transitory computer-readable medium of claim 15, wherein modifying the sequence of intermediate curve networks by minimizing a thin-shell energy of at least one intermediate curve network with respect to a vector of curve network parameters of the at least one intermediate curve network.

17. The non-transitory computer-readable medium of claim 15, wherein the operations further include:
modifying a particular intermediate curve network of the sequence of intermediate curve networks;
defining a new destination keyframe including a third representation of the curve network corresponding to the particular intermediate curve network; and
generating a new sequence of intermediate curve networks representing poses of the animated object between the initial keyframe and the new destination keyframe.

18. The non-transitory computer-readable medium of claim 15, wherein rendering the initial keyframe includes:
defining surface deformation gradients using the initial keyframe representation of the curve network.

19. The non-transitory computer-readable medium of claim 15, wherein the operations further include:
reducing the linear operator by removing values that are less than a threshold value; and
applying the linear operator to the sequence of intermediate curve networks during rendering.

20. The non-transitory computer-readable medium of claim 15, wherein interpolating from the initial keyframe to the destination keyframe using the curve network includes:
modifying edge lengths and dihedral angles of a curve network of the initial keyframe to represent a common mesh-based thin-shell energy with respect to diffused Jacobians; and
interpolating the edge lengths and the dihedral angles of the curve network of the initial keyframe.
